(19) United States
(12) Patent Application Publication
(10) Pub. No.: US 2019/0026442 A1
(43) Pub. Date: Jan. 24, 2019

(54) OFFLINE ACTIVATION FOR APPLICATION(S) INSTALLED ON A COMPUTING DEVICE

(71) Applicant: Microsoft Technology Licensing, LLC, Redmond, WA (US)

(72) Inventors: Brian Perlman, Bothell, WA (US); Hakki T. Bostanci, Redmond, WA (US); Olaf Alexander Miller, Bellevue, WA (US); Siddharth Mantri, Kirkland, WA (US); Valentin Sliouniaev, Redmond, WA (US); Aaron J. Smith, Kenmore, WA (US); Sudeep Kumar Ghosh, Kirkland, WA (US)

(21) Appl. No.: 15/801,144

(22) Filed: Nov. 1, 2017

Related U.S. Application Data
(60) Provisional application No. 62/536,384, filed on Jul. 24, 2017.

(51) Int. Cl. G06F 21/12; G06F 21/10; G06F 9/44

(52) U.S. Cl. CPC G06F 21/126; G06Q 50/184; G06F 9/4406; G06F 21/105

(57) ABSTRACT

Embodiments described herein enable a device to be activated/re-activated offline using device-bound activation/licensing information stored in that device's firmware. By storing the necessary licensing data in the device's firmware, the loss of data when the operating system software is reinstalled is avoided. The foregoing may be accomplished by “binding” data into the licensing data. This is done in order to make the license unusable on a different device, even on the exact same model of the device. Right-of-use information indicating which software components, versions, editions, configurations, etc. are licensed for use may also be included. The licensing data may also be provisioned to the device's firmware during device manufacturing to avoid the need for the user to contact the licensor company when the device reaches the end user. The process of issuing the device-bound license can also be delegated to another party by means of an issuance license.

### CROSS REFERENCE TO RELATED APPLICATION

This application claims priority to U.S. Provisional Application Ser. No. 62/536,384, filed Jul. 24, 2017 and entitled “Offline Device Licensing Using Data Stored in Device Firmware,” the entirety of which is incorporated by reference herein.

### BACKGROUND

A common problem with licensing software is that it requires some form of data exchange with the licensor. This typically happens during an “activation” process that can be performed either over the Internet, phone, or via a proxy (for example, submitting a request and receiving a response via email). Another common problem is that the licensing information received during activation is lost when the software is reinstalled, for example, during operating system reimaging, replacement of the hard disk, etc.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein enable a device (e.g., a computer device) to be activated/re-activated offline using device-bound activation/licensing information stored in that device's firmware. By storing the necessary licensing data in the device's firmware, the loss of data when the operating system software is reinstalled is avoided. The foregoing may be accomplished by “binding” data into the licensing data. This is done in order to make the license unusable on a different device, even on the exact same model of the device. Right-of-use (or “grant”) information indicating which software components, versions, editions, configurations, etc. are licensed for use may also be included. The licensing data may also be provisioned to the device's firmware during device manufacturing to avoid the need for the user to contact the licensor company when the device reaches the end user. The process of issuing the device-bound license can also be delegated to another party by means of an issuance license.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for delegating authority to generate licensing data to a manufacturer of computing devices in accordance with an embodiment.

FIG. 2 shows a flowchart of a method for delegating authority to generate licensing data to a manufacturer of computing devices in accordance with an embodiment.

FIG. 3 shows a block diagram of an example system for storing licensing data in firmware of a computing device in accordance with an embodiment.

FIG. 4 shows a flowchart of a method for storing licensing data in firmware of a computing device in accordance with an embodiment.

FIG. 5 shows a block diagram of an example computing device in accordance with an embodiment.

FIG. 6 shows a flowchart of a method for offline activation of software installed on a computing device in accordance with an embodiment.

FIG. 7 is a block diagram of an example computing device that may be used to implement embodiments.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Previously, almost all forms of activation (e.g., online activation, phone activation, domain activation, etc.) required the end user of a computing device to perform a process that involved communication with another computing device (e.g., an activation server). This presented difficulties in certain scenarios (e.g., when connection to the activation server could not be established). Because the license was stored on the hard disk of the computing device that required activation, it was lost when the disk was replaced or software was erased from the disk.

Embodiments described herein enable a device (e.g., a computer device) to be activated/re-activated offline using device-bound activation/licensing information in that device's firmware. By storing the necessary licensing data in the device's firmware, the loss of data when the operating system software is reinstalled is avoided. The foregoing may be accomplished by “binding” data into the licensing data. This is done in order to make the license unusable on a different device, even on the exact same model of the device. Right-of-use (or “grant”) information indicating which software components, versions, editions, configurations, etc. are licensed for use may also be included. The licensing data may also be provisioned to the device's firmware during device manufacturing to avoid the need for the user to contact the licensor company when the device reaches the end user. The process of issuing the device-bound license can also be delegated to another party by means of an issuance license.

A. Delegating Authority to Generate Licensing Data to a Manufacturer of Computing Devices

FIG. 1 shows a block diagram of an example system 100 for delegating authority to generate licensing data to a manufacturer (e.g., an Original Equipment Manufacturer) of computing devices, according to an example embodiment. As shown in FIG. 1, system 100 includes an activation server 102 and a license server 104. Activation server 102 may comprise one or more servers that are maintained by and/or located at a facility maintained by a manufacturer of computing devices (e.g., mobile phones, laptops, tablets, and desktop computers, etc.). License server 104 may comprise one or more servers that are maintained by a developer, publisher, and/or distributor of one or more software applications. The developer, publisher, and/or distributer may provide licensing data (also referred to as a “license,” a “device marker,” or a “device license”) for the software application(s) to authorize the usage thereof (e.g., on the computing device(s) manufactured by the manufacturer). The developer, publisher, and/or distributer may be referred to as a “licensor.” License server 104 may be also be maintained by any entity for which authorization is given by the licensor to grant licenses. Such an entity may be referred to as an “immediate authority”.

In accordance with an embodiment, the licensor or immediate authority delegates the authority to generate licenses to the manufacturer. For example, as shown in FIG. 1, activation server 102 may comprise a secure environment 106 that comprises a signing key 108 that is authorized by the licensor and/or immediate authority. The secure environment 106 may comprise a trusted platform module (TPM), a hardware security module (HSM), or any type of secure hardware and/or software-based cryptoprocessor. Signing key 108 may comprise a public-private key pair. Secure environment 106 is configured to protect the private key from being extracted out by an external entity. Signing key 108 may be generated and provided by the licensor (e.g., by a server maintained by the licensor, such as license server 104).

In order to receive authorization to generate licensing data, activation server 102 may provide a request 110 that includes the public key of the public-private key pair to license server 104. In response, license server 104 determines whether the public key was generated in a secure environment (e.g., secure environment 106) trusted by license server 104 and/or is a public key that is trusted by license server 104. For example, license server 104 may determine whether the public key is stored in one or more databases 116 comprising a list of trusted public keys. Responsive to determining that the public key is trusted, license server 104 provides a response 112 that includes an issuance (or “keyholder”) license to activation server 102. The issuance license authorizes the private key of the public-private key pair, thereby authorizing the manufacturer to generate licensing data. The issuance license contains a signature that verifies that the issuance license originates from the licensor and/or intermediate authority, the public key, and/or one or more restrictions associated with the licensing data. For example, the restriction(s) may specify that activation server 102 is enabled to generate a certain number (e.g., a maximum number) of licensing data instances, may specify that activation server 102 is enabled to generate licensing data for a predetermined period of time (e.g., 6 months, 1 year, etc.), one or more versions, editions or configurations of a software application authorized to be activated by the licensing data, and/or any combination thereof.

Once the issuance license is received, the manufacturer is authorized to generate licensing data in accordance with the restrictions specified by the issuance license, and further communication with license server 104 is no longer required for license generation purposes. At this point, the manufacturer can work in a disconnected environment without any interference from an external entity (e.g., a foreign government attempting to hack and/or disable the manufacturer's ability to generate licensing data) or dependency on external data. Activation server 104 may reinitiate communication with license server 104 if another issuance license to generate more licensing data is desired.

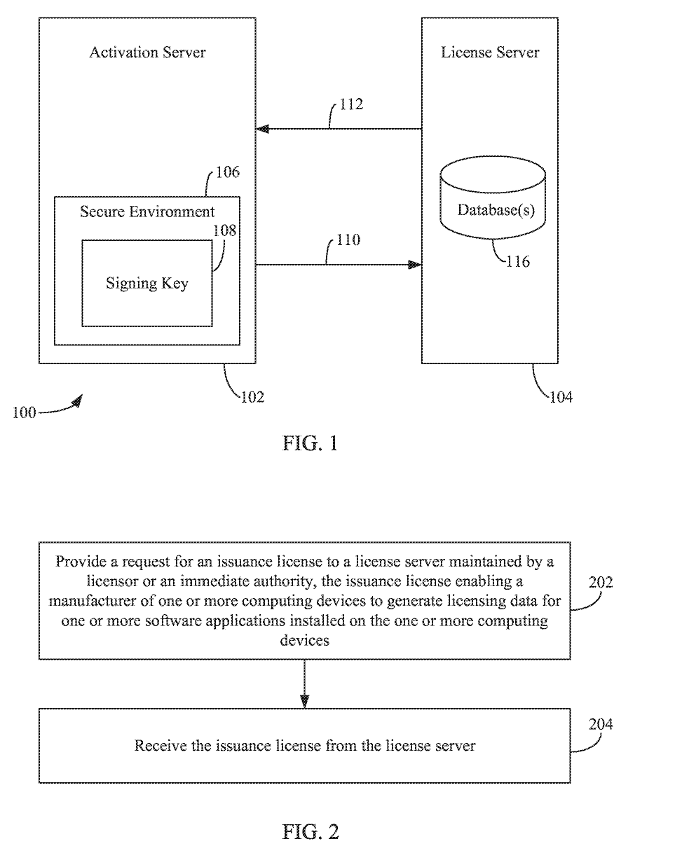

Accordingly, the generation of licensing data may be delegated to a manufacturer of computing device(s) in many ways. For example, FIG. 2 shows a flowchart 200 for delegating authority to generate licensing data to a manufacturer of computing devices, according to an example embodiment. In an embodiment, flowchart 200 may be implemented by system 100, as shown in FIG. 1. Other structural and operational embodiments will be apparent to persons skilled in the relevant art(s) based on the following discussion regarding flowchart 200 and system 100 of FIG. 1.

Flowchart 200 begins with step 202. In step 202, a request for an issuance license is provided to a license server maintained by a licensor or an immediate authority. The issuance license enables a manufacturer of computing device(s) to generate licensing data for software application(s) installed on the computing device(s). For example, with reference to FIG. 1, activation server 102 provides a request 110 for an issuance license to license server 104.

In step 204, the issuance license is received from the license server. For example, with reference to FIG. 2, activation server 102 receives the issuance license via response 112, which is provided by license server 104.

It is noted that an intermediate authority may be provided authorization from the licensor to provide an issuance license to one or more other intermediate authorities. The issuance licenses for the other intermediate authorit(ies) may inherit the restrictions of the parent intermediate authority and may also be more restrictive in terms of the number of licensing data instances that may be generated, the period of time in which licensing data instances may be generated, and/or the version(s), edition(s) or configuration(s) of the software application(s) that are authorized to be activated by the licensing data.

B. Storing Licensing Data in Firmware of a Computing Device

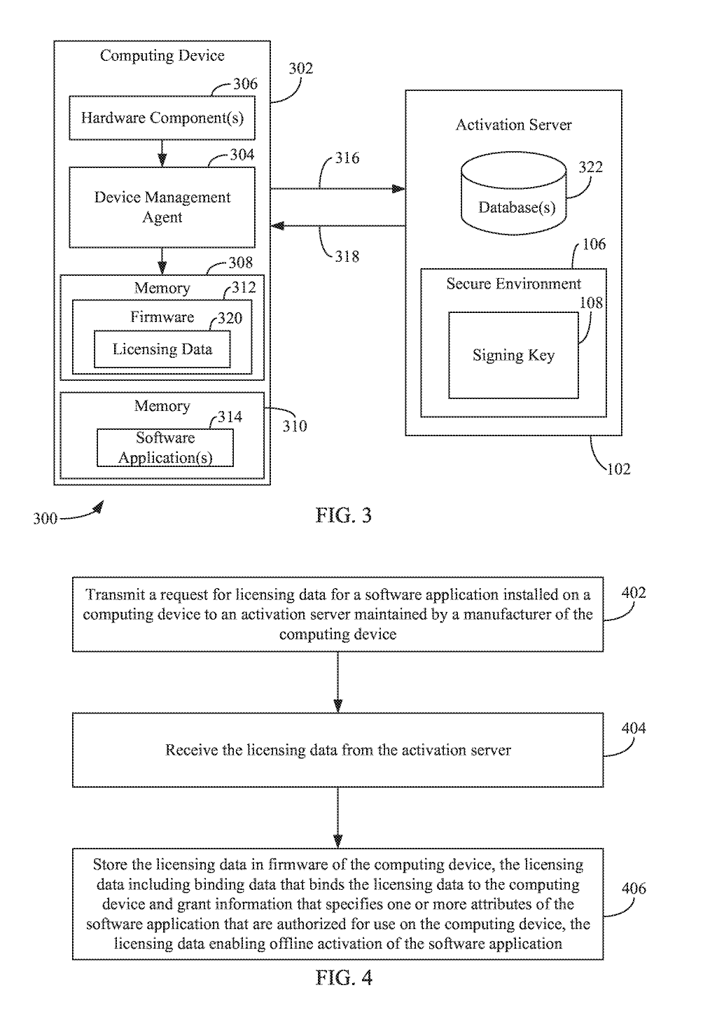

As described in Subsection A, after receiving the issuance license from the licensor and/or immediate authority, the manufacturer is enabled to generate licensing data for computing devices manufactured thereby. For example, FIG. 3 shows a block diagram of an example system 300 for storing licensing data in firmware of a computing device, according to an example embodiment. As shown in FIG. 3, system 300 includes activation server 102 and a computing device 302. Computing device 302 represents a device manufactured by a manufacturer (that may also maintain activation server 102). Examples of computing device 302 include a mobile device such as a mobile computer or mobile computing device (e.g., a Microsoft® Surface® device, a personal digital assistant (PDA), a laptop computer, a notebook computer, a tablet computer such as an Apple iPad™, a netbook, etc.), a smart phone, a wearable computing device (e.g., a head-mounted device including smart glasses such as Google® Glass™, etc.), or other type of mobile device, or a stationary computing device such as a desktop computer, server, a video game console, or PC (personal computer).

Computing device 302 and activation server 102 may be communicatively coupled via a network (e.g., a LAN (local area network), a WAN (wide area network), or any combination of networks, such as the Internet). As shown in FIG. 3, computing device 302 comprises a device management agent 304, one or more hardware components 306, a first memory 308, and a second memory 310. First memory 308 stores firmware 312 of computing device 302. Firmware 312 may be any type of firmware, including Basic Input/Output System (BIOS)-based, Unified Extensible Firmware Interface (UEFI)-based, and/or the like. First memory 308 may be a non-volatile memory, such as a Read-Only Memory (ROM), an erasable programmable ROM (EPROM), flash memory, and/or other type of physical memory. Second memory 110 stores one or more software applications 314 that are installed onto computing device 302 by the manufacturer. Examples of software application(s) 314 include, but are not limited to, an operating system (Microsoft® Windows™), productivity software (e.g., Microsoft® Word™, Microsoft® Excel™, etc., and/or a suite of software (e.g., Microsoft® Office 365™) comprising such productivity software. Examples of second memory 310 comprise a hard disk, a solid state drive, or other type of physical memory. An example of device management agent 304 includes, but is not limited to, an OEM Activation Tool (e.g., OEM Activation (OA) 3.0 by Microsoft®).

Before the manufacturer ships the device to a consumer or reseller, device management agent 304 may be configured to generate hardware binding data for computing device 302. The hardware binding data may be based on identifiers of one or more hardware components 306, first memory 308 and/or second memory 310 included in computing device 302. Examples of hardware components 306 include, but are not limited to, CD-ROM drives, DVD-ROM drives, BLU-RAY drives, network cards, processors, memories (e.g., random access memories (RAMs)), display adapters, etc. Examples of identifiers include, but are not limited to, serial numbers, media access control numbers, device identifiers, and/or any identifier that uniquely identifies such hardware components. In accordance with an embodiment, device management agent 304 may determine the identifiers of hardware component(s) 306, first memory 308 and/or second memory 310 and generate an identifier (e.g., a hash value) representative of the determined identifiers using a hash function. The hardware binding data may comprise the identifier.

To obtain licensing data used to activate software application(s) 314 installed on computing device 302, device management agent 304 may send a request 316 including the hardware binding data and an identifier (e.g., a Stock Keeping Unit (SKU)) of software application(s) 314 for which activation is desired to activation server 102. For example, the identifier may specify the name, version, edition, etc. of software application(s) 314. Activation server 102 may be communicatively coupled to a database (e.g., one or more databases 322) or other data source that maintains hardware binding data for each computing device manufactured by the manufacturer for which licensing data has been generated. Activation server 102 may determine whether hardware binding data received from device management agent 304 is stored in database(s) 322. If a determination is made that the hardware binding data is stored in database(s) 322, activation server 102 determines that licensing data has already been provided to computing device 302 and does not provide the licensing data. If a determination is made that the hardware binding data is not stored in database(s) 322, activation server 102 determines whether the issuance license authorizes activation server 102 to generate licensing data for the software application(s) identified by the identifier. If the issuance license authorizes activation server 102 to generate licensing data for such software application(s), activation server 102 generates the licensing data, signs the licensing data using the private key of the public-private key pair of signing key 108 (i.e., the licensing data includes a signature that verifies that the licensing data is provided by an authorized entity (i.e., the manufacturer)), and provides a response 318 including the signed licensing data, the hardware binding data, and grant information that specifies one or more attributes of the software application that are authorized for use on the computing device. Such attributes may include, but are not limited to one or more versions of the software application, one or more editions of the software application, or one or more configurations of the software application.

The hardware binding data binds licensing data 320 such that licensing data 320 only works on computing device 302. Any attempt to copy licensing data 320 to another computing device for software application(s) installed thereon will fail as a result of that other computing device having a different hardware configuration and/or components. Moreover, because licensing data 320 is stored locally in firmware 312, software application(s) 314 may be activated offline. For example, computing device 302 may not be connected to a network (e.g., such as the Internet) and therefore, not communicatively coupled to a license server (e.g., license server 104 or activation server 102) from which licensing data may be obtained. Additional details regarding operations performed by computing device 302 to activate software application(s) 314 in accordance with licensing data 320 is described below in Subsection C. Response 318 may also include the issuance license. Device management agent 304 may store the issuance license in firmware 320 or in an image file of software application(s) 314 (e.g., an operating system image).

Upon receiving response 318, device management agent 304 stores the licensing data (shown as licensing data 320) in firmware 312. After licensing data 320 is stored in firmware 320, the manufacturer may ship computing device 302 to a consumer or reseller.

The foregoing process may be repeated for each computing device manufactured by the manufacturer so long as the licensing data generation for such computing device(s) is in accordance with the restriction(s) specified by the issuance license granted to activation server 102.

The foregoing advantageously limits the manufacture to only generate licensing data in accordance with the restrictions specified by the issuance license, thereby preventing the manufacturer from producing unauthorized, gray market devices comprising software application(s) for which the manufacturer is not authorized to sell.

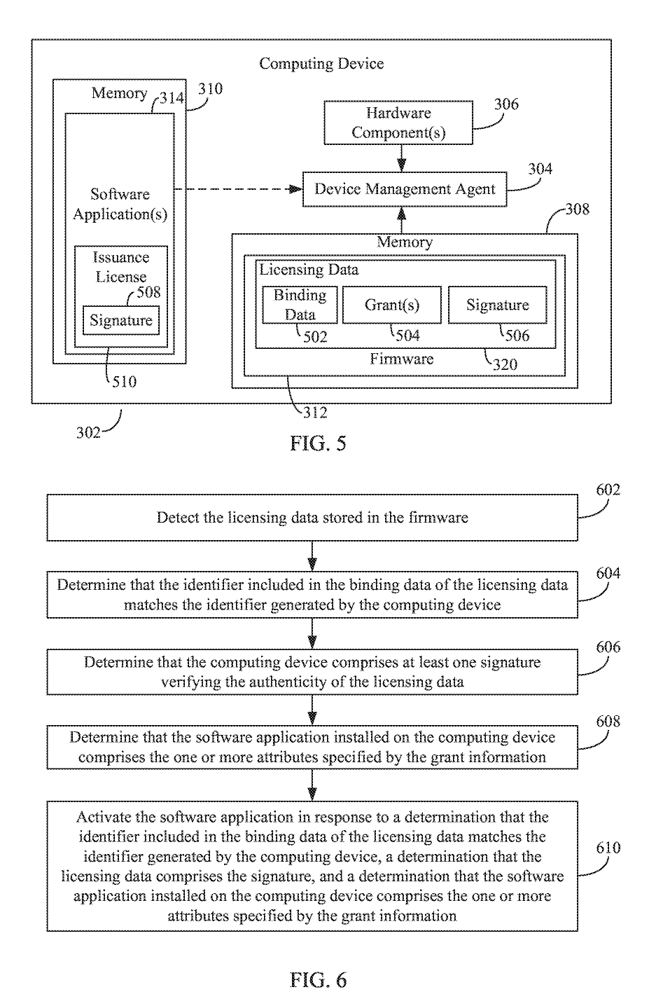

Accordingly, licensing data may be stored in the firmware of a computing device in many ways. For example, FIG. 4 shows a flowchart 400 for storing licensing data in firmware of a computing device, according to an example embodiment. In an embodiment, flowchart 400 may be implemented by system 300, as shown in FIG. 3. Other structural and operational embodiments will be apparent to persons skilled in the relevant art(s) based on the following discussion regarding flowchart 400 and system 300 of FIG. 3.

Flowchart 400 begins with step 402. In step 402, a request for licensing data for a software application installed on a computing device is transmitted to an activation server maintained by a manufacturer of the computing device. For example, with reference with FIG. 3, computing device 302 transmits request 316 for licensing data for software application(s) 314 installed on computing device 302 to activation server 102 maintained by a manufacturer of computing device 302.

In step 404, the licensing data from the activation server is received. For example, with reference to FIG. 3, computing device 302 receives licensing data 320 from activation server 102 via response 318.

In step 406, the licensing data is stored in firmware of the computing device. The licensing data includes binding data that binds the licensing data to the computing device and grant information that specifies one or more attributes of the software application that are authorized for use on the computing device. The licensing data enables offline activation of the software application. For example, with reference to FIG. 3, device management agent 304 stores licensing data 320 received via response 318 in firmware 312.

In accordance with one or more embodiments, the attribute(s) include one or more versions of the software application, one or more editions of the software application, or one or more configurations of the software application.

In accordance with one or more embodiments, an identifier that identifies the computing device is generated, the identifier being based on at least one hardware parameter of at least one hardware component included in the computing device, the request including the identifier. For example, with reference to FIG. 4, request 316 includes an identifier (i.e., the hardware binding data) that identifies computing device 302. The identifier may be based on at least one hardware parameter one or more of hardware component(s) 306, memory 308 and/or memory 310.

In accordance with one or more embodiments, the at least one hardware parameter comprises one or more of a serial number of the at least one hardware component, a media access control number of the at least one hardware component, or a device identifier of the at least one hardware component.

In accordance with one or more embodiments, the binding data comprises the identifier. Activation server 102 may use the identifier (also referred to as hardware binding data) received via request 316 to determine whether computing device 302 has already received licensing data. Upon determining that computing device 302 has not previously received licensing data, activation server 102 provides the hardware binding data (with licensing data 320) via response 318.

C. Offline Activation of Software Application(s) Installed on a Computing Device

After computing device (e.g., computing device 302) is activated for the first time (e.g., powered on) by the consumer, software application(s) installed on the computing device for which licensing data is stored in the computing device's firmware may be automatically activated using the licensing data. The foregoing may be achieved during the boot up process of the computing device or shortly after the computing device has completed the boot up process. The foregoing is achieved without requiring any communication to a device (e.g., a server, such as activation server 102 and/or license server 104) external to computing device 102. That is, software activation is achievable while the computing device is offline (i.e., not connected to a network).

For example, FIG. 5, shows a block diagram of computing device 302, according to an example embodiment. Device management agent 304 may be configured to activate software application(s) 314 after activation of computing device 302 using licensing data 320. As shown in FIG. 5, licensing data 320 comprises binding data 502, grant information 504, and one or more signatures 506. As further shown in FIG. 5, software application(s) 314 include an issuance license 510 comprising a signature 508 that verifies that issuance license 510 originates from a trusted licensor and/or intermediate authority. Issuance license 510 may be stored in an image file of software application(s) 314. It is noted that while issuance license 510 and signature 508 are included in software application(s) 314, as an alternative, issuance license 510 and signature 508 may be stored in firmware 312.

Upon computing device 302 being activated the first time, device management agent 304 may be configured to determine whether licensing data 320 is stored in firmware 312. Upon detecting licensing data 320, device management agent 304 may perform a verification process to determine the authenticity of licensing data 320. For instance, in an embodiment in which a licensor authorizes an intermediate authority to grant issuance licenses, signature 506 may indicate that the licensing data is signed by an entity authorized to provide the licensing data (i.e., the manufacturer), and signature 508 may indicate that the issuance license was provided by any entity authorized to provide the issuance license 510 (i.e., the licensor and/or intermediate authority). Device management agent 304 determines whether issuance license 510 includes signature 508 and whether licensing data 320 includes signature 506, and further determines the authenticity of signature 508 and signature 510, thereby verifying the chain of signatures back to the original licensor.

Device management agent 304 may determine whether the hardware configuration of computing device 302 matches binding data 502 including in licensing data 320. For example, device management agent 304 may generate hardware binding data based on identifiers of one or more hardware components 306, first memory 308 and/or second memory 310 included in computing device 302 as described above in Subsection B. The generated hardware binding data is compared to an identifier included in binding data 502 that is representative a particular hardware configuration and/or configuration for which licensing data 320 is bound. If the generated hardware binding data does not match the identifier included in binding data 502, device management 304 determines that licensing data 320 is not valid and software application(s) 314 are not activated.

Device management agent 304 may also determine whether software application(s) 314 comprise the attribute(s) that are specified by grant information 504. For example, grant information 504 may specify that licensing data 320 is only valid for a particular edition, version, and/or configuration of software application(s) 314. If software application(s) 314 does not comprise the same attribute(s) specified by grant information 504, device management agent 304 determines that licensing data 320 is not valid and software application(s) 314 are not activated. For instance, a software application of software application(s) 314 installed on computing device 302 may be Windows 10 Home Edition, but grant information 504 specifies that licensing data 320 is only valid for Windows 10 Professional Edition.

Responsive to determining that the licensing data 320 and/or issuance license 510 comprises valid signatures (i.e., signature 506 and signature 508), that the generated binding data matches the identifier included in binding data 502, and that software application(s) 314 comprise attribute(s) specified by grant information 504, device management agent 304 activates the software application(s) of software application(s) 314 specified by licensing data 320.

Offline activation of software application(s) specified by licensing data 320 can still be carried out even if such software application(s) are re-installed onto computing device 320. Because licensing data 320 is stored in firmware 320, such data is not lost if the software application(s) are deleted and subsequently re-installed onto the computing device. Moreover, in an embodiment in which the memory (e.g., second memory 310) in which the software applications are installed are not factored into the binding data, offline activation of such software application may be carried out even if the memory is replaced.

Accordingly, software application(s) may be activated while the computing device in which they are installed is offline in many ways. For example, FIG. 6 shows a flowchart 600 of a method for offline activation of software installed on a computing device, according to an example embodiment. In an embodiment, flowchart 600 may be implemented by system 500, as shown in FIG. 5. Other structural and operational embodiments will be apparent to persons skilled in the relevant art(s) based on the following discussion regarding flowchart 600 and system 500 of FIG. 5.

Flowchart 600 begins with step 602. In step 602, licensing data stored in firmware is detected. For example, with reference with FIG. 5, device management agent 304 detects licensing data 320 in firmware 312.

In step 604, a determination is made that the identifier included in the binding data of the licensing data matches the identifier generated by the computing device. For example, with reference to FIG. 5, device management agent 304 determines that the identifier included in binding data 502 of licensing data 320 matches the identifier generated by computing device 302 (i.e., the hardware binding data generated by device management agent 304 of computing device 302).

In step 606, a determination is made that the computing device comprises at least one signature verifying the authenticity of the licensing data. For example, with reference to FIG. 5, device management agent 304 determines that computing device 302 comprises at least one of signature 506 or signature 508 to verify the authenticity of licensing data 320.

In accordance with one or more embodiments, the at least one signature (e.g., signature 506) indicates that the licensing data is signed by an entity authorized to provide the licensing data.

In step 608, a determination is made that the software application installed on the computing device comprises the one or more attributes specified by the grant information. For example, with reference to FIG. 5, device management agent 304 determines that software application(s) 314 installed on computing device 302 comprises attribute(s) specified by grant information 504.

In step 610, the software application is activated in response to a determination that the identification included in the binding data of the licensing data matches the identification generated by the computing device, a determination that the licensing data comprises the signature, and a determination that the software application installed on the computing device comprises the one or more attributes specified by the grant information. For example, with reference to FIG. 5, device management agent 304 activates software application(s) 314 in response to a determination that the identifier included in binding data 502 matches the identifier (i.e., the hardware binding data) generated by computing device 304, a determination that licensing data 320 comprises signature 506 (and/or determines that issuance license 508 comprise signature 508), and a determination that software application(s) 314 comprise attribute(s) specified by grant information 504.

### III. Example Computer System Implementation

Activation server 102, license server 104, computing device 302, any one or more of their components, flowchart 200, flowchart 400 and/or flowchart 600 may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

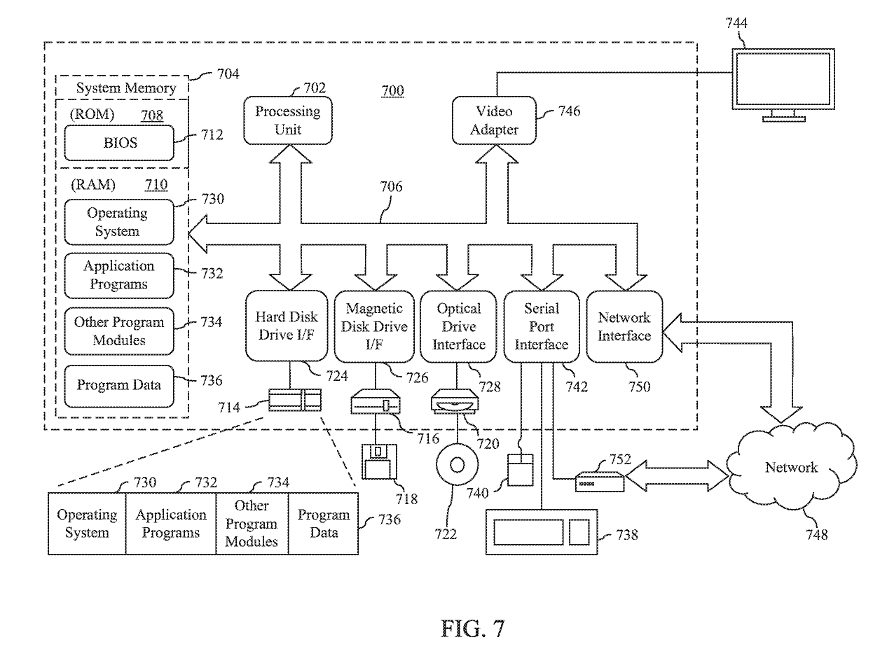

FIG. 7 depicts an example processor-based computer system 700 that may be used to implement various embodiments described herein. For example, system 700 may be used to implement activation server 102, license server 104, computing device 302, as described above in reference to FIGS. 1, 3 and 5. System 700 may also be used to implement any of the steps of any of the flowcharts of FIGS. 2, 4, and 6, as described above. The description of system 800 provided herein is provided for purposes of illustration, and is not intended to be limiting. Embodiments may be implemented in further types of computer systems, as would be known to persons skilled in the relevant art(s).

As shown in FIG. 7, system 700 includes a processing unit 702, a system memory 704, and a bus 706 that couples various system components including system memory 704 to processing unit 702. Processing unit 702 may comprise one or more circuits (e.g. processor circuits), microprocessors or microprocessor cores. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random access memory (RAM) 710. A basic input/output system 712 (BIOS) is stored in ROM 708.

System 700 also has one or more of the following drives: a hard disk drive 714 for reading from and writing to a hard disk, a magnetic disk drive 716 for reading from or writing to a removable magnetic disk 717, and an optical disk drive 720 for reading from or writing to a removable optical disk 722 such as a CD ROM, DVD ROM, BLU-RAY™ disk or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 730, one or more application programs 732, other program modules 734, and program data 736. In accordance with various embodiments, the program modules may include computer program logic that is executable by processing unit 702 to perform any or all of the functions and features of activation server 102, license server 104, computing device 302, and/or any one or more of their components, as described above in reference to FIGS. 1, 3 and 5. The program modules may also include computer program logic that, when executed by processing unit 702, causes processing unit 702 to perform any of the steps of any of the flowcharts of FIGS. 2, 4, and 6, as described above.

A user may enter commands and information into system 700 through input devices such as a keyboard 738 and a pointing device 740 (e.g., a mouse). Other input devices (not shown) may include a microphone, joystick, game controller, scanner, or the like. In one embodiment, a touch screen is provided in conjunction with a display 744 to allow a user to provide user input via the application of a touch (as by a finger or stylus for example) to one or more points on the touch screen. These and other input devices are often connected to processing unit 702 through a serial port interface 742 that is coupled to bus 706, but may be connected by other interfaces, such as a parallel port, game port, or a universal serial bus (USB). Such interfaces may be wired or wireless interfaces.

Display 744 is connected to bus 706 via an interface, such as a video adapter 746. In addition to display 744, system 700 may include other peripheral output devices (not shown) such as speakers and printers.

System 700 is connected to a network 748 (e.g., a local area network or wide area network such as the Internet) through a network interface 750, a modem 752, or other suitable means for establishing communications over the network. Modem 752, which may be internal or external, is connected to bus 706 via serial port interface 742.

As used herein, the terms “computer program medium,” “computer-readable medium,” and “computer-readable storage medium” are used to generally refer to memory devices or storage structures such as the hard disk associated with hard disk drive 714, removable magnetic disk 718, removable optical disk 722, as well as other memory devices or storage structures such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 732 and other program modules 734) may be stored on the hard disk, magnetic disk, optical disk, ROM, or RAM. Such computer programs may also be received via network interface 750, serial port interface 742, or any other interface type. Such computer programs, when executed or loaded by an application, enable system 700 to implement features of embodiments discussed herein. Accordingly, such computer programs represent controllers of the system 700. Embodiments are also directed to computer program products comprising software stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

### IV. Additional Example Embodiments

In one embodiment, a computing devices comprises: at least one processor circuit; and at least one memory that stores program code configured to be executed by the at least one processor circuit, the program code comprising: a device management agent configured to: transmit a request for licensing data for a software application installed on the computing device to an activation server maintained by a manufacturer of the computing device; receive the licensing data from the activation server; and store the licensing data in firmware of the computing device, the licensing data including binding data that binds the licensing data to the computing device and grant information that specifies one or more attributes of the software application that are authorized for use on the computing device, the licensing data enabling offline activation of the software application.

In an embodiment, the device management agent is further configured to: generate an identifier that identifies the computing device, the identifier being based on at least one hardware parameter of at least one hardware component included in the computing device, wherein the request includes the identifier.

In an embodiment, the binding data comprises the identifier.

In an embodiment, the at least one hardware parameter comprises one or more of:

a serial number of the at least one hardware component; a media access control number of the at least one hardware component; or a device identifier of the at least one hardware component.

In an embodiment, the device management agent is further configured to: detect the licensing data stored in the firmware; determine that the identifier included in the binding data of the licensing data matches the identifier generated by the computing device; determine that the computing device comprises at least one signature verifying the authenticity of the licensing data; determine that the software application installed on the computing device comprises the one or more attributes specified by the grant information; and activate the software application in response to a determination that the identifier included in the binding data of the licensing data matches the identifier generated by the computing device, a determination that the licensing data comprises the signature, and a determination that the software application installed on the computing device comprises the one or more attributes specified by the grant information.

In an embodiment, the at least one signature indicates that the licensing data is signed by an entity authorized to provide the licensing data.

In an embodiment, the one or more attributes comprise: one or more versions of the software application; one or more editions of the software application; or one or more configurations of the software application.

In an embodiment, a method performed by a computing device comprises:

transmitting a request for licensing data for a software application installed on the computing device to an activation server maintained by a manufacturer of the computing device; receiving the licensing data from the activation server; and storing the licensing data in firmware of the computing device, the licensing data including binding data that binds the licensing data to the computing device and grant information that specifies one or more attributes of the software application that are authorized for use on the computing device, the licensing data enabling offline activation of the software application.

In an embodiment, the method further comprises: generating an identifier that identifies the computing device, the identifier being based on at least one hardware parameter of at least one hardware component included in the computing device, wherein the request includes the identifier.

In an embodiment, the binding data comprises the identifier.

In an embodiment, the at least one hardware parameter comprises one or more of:

a serial number of the at least one hardware component; a media access control number of the at least one hardware component; or a device identifier of the at least one hardware component.

In an embodiment, the method further comprises: detecting the licensing data stored in the firmware; determining that the identifier included in the binding data of the licensing data matches the identifier generated by the computing device; determining that the computing device comprises at least one signature verifying the authenticity of the licensing data; determining that the software application installed on the computing device comprises the one or more attributes specified by the grant information; and activating the software application in response to determining that the identifier included in the binding data of the licensing data matches the identifier generated by the computing device, determining that the licensing data comprises the signature, and determining that the software application installed on the computing device comprises the one or more attributes specified by the grant information.

In an embodiment, the at least one signature indicates that the licensing data is signed by an entity authorized to provide the licensing data.

In an embodiment, the one or more attributes comprise: one or more versions of the software application; one or more editions of the software application; or one or more configurations of the software application.

In an embodiment, a computer-readable storage medium having program instructions recorded thereon that, when executed by at least one processor, perform a method for enabling offline activation for a software application installed on a computing device, the method comprising: transmitting a request for licensing data for a software application installed on the computing device to an activation server maintained by a manufacturer of the computing device; receiving the licensing data from the activation server; and storing the licensing data in firmware of the computing device, the licensing data including binding data that binds the licensing data to the computing device and grant information that specifies one or more attributes of the software application that are authorized for use on the computing device, the licensing data enabling offline activation of the software application.

In an embodiment, the method further comprises: generating an identifier that identifies the computing device, the identifier being based on at least one hardware parameter of at least one hardware component included in the computing device, wherein the request includes the identifier.

In an embodiment, the binding data comprises the identifier.

In an embodiment, the at least one hardware parameter comprises one or more of:

a serial number of the at least one hardware component; a media access control number of the at least one hardware component; or a device identifier of the at least one hardware component.

In an embodiment, the method further comprises: detecting the licensing data stored in the firmware; determining that the identifier included in the binding data of the licensing data matches the identifier generated by the computing device; determining that the computing device comprises at least one signature verifying the authenticity of the licensing data; determining that the software application installed on the computing device comprises the one or more attributes specified by the grant information; and activating the software application in response to determining that the identifier included in the binding data of the licensing data matches the identifier generated by the computing device, determining that the licensing data comprises the signature, and determining that the software application installed on the computing device comprises the one or more attributes specified by the grant information.

In an embodiment, the at least one signature indicates that the licensing data is signed by an entity authorized to provide the licensing data.

### V. Conclusion

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A computing device, comprising:
at least one processor circuit; and
at least one memory that stores program code configured to be executed by the at least one processor circuit, the program code comprising:
a device management agent configured to:
transmit a request for licensing data for a software application installed on the computing device to an activation server maintained by a manufacturer of the computing device;
receive the licensing data from the activation server; and
store the licensing data in firmware of the computing device, the licensing data including binding data that binds the licensing data to the computing device and grant information that specifies one or more attributes of the software application that are authorized for use on the computing device, the licensing data enabling offline activation of the software application.

2. The computing device of claim 1, the device management agent further configured to:
generate an identifier that identifies the computing device, the identifier being based on at least one hardware parameter of at least one hardware component included in the computing device, wherein the request includes the identifier.

3. The computing device of claim 2, wherein the binding data comprises the identifier.

4. The computing device of claim 2, wherein the at least one hardware parameter comprises one or more of:
a serial number of the at least one hardware component;
a media access control number of the at least one hardware component; or
a device identifier of the at least one hardware component.

5. The computing device of claim 2, the device management agent further configured to:
detect the licensing data stored in the firmware;
determine that the identifier included in the binding data of the licensing data matches the identifier generated by the computing device;
determine that the computing device comprises at least one signature verifying the authenticity of the licensing data;
determine that the software application installed on the computing device comprises the one or more attributes specified by the grant information; and
activate the software application in response to a determination that the identifier included in the binding data of the licensing data matches the identifier generated by the computing device, a determination that the licensing data comprises the signature, and a determination that the software application installed on the computing device comprises the one or more attributes specified by the grant information.

6. The computing device of claim 5, wherein the at least one signature indicates that the licensing data is signed by an entity authorized to provide the licensing data.

7. The computing device of claim 1, wherein the one or more attributes comprise:
one or more versions of the software application;
one or more editions of the software application; or
one or more configurations of the software application.

8. A method performed by a computing device, comprising:
transmitting a request for licensing data for a software application installed on the computing device to an activation server maintained by a manufacturer of the computing device;
receiving the licensing data from the activation server; and
storing the licensing data in firmware of the computing device, the licensing data including binding data that binds the licensing data to the computing device and grant information that specifies one or more attributes of the software application that are authorized for use on the computing device, the licensing data enabling offline activation of the software application.

9. The method of claim 8, further comprising:
generating an identifier that identifies the computing device, the identifier being based on at least one hardware parameter of at least one hardware component included in the computing device, wherein the request includes the identifier.

10. The method of claim 9, wherein the binding data comprises the identifier.

11. The method of claim 9, wherein the at least one hardware parameter comprises one or more of:
a serial number of the at least one hardware component;
a media access control number of the at least one hardware component; or
a device identifier of the at least one hardware component.

12. The method of claim 9, further comprising:
detecting the licensing data stored in the firmware;
determining that the identifier included in the binding data of the licensing data matches the identifier generated by the computing device;
determining that the computing device comprises at least one signature verifying the authenticity of the licensing data;
determining that the software application installed on the computing device comprises the one or more attributes specified by the grant information; and
activating the software application in response to determining that the identifier included in the binding data of the licensing data matches the identifier generated by the computing device, determining that the licensing data comprises the signature, and determining that the software application installed on the computing device comprises the one or more attributes specified by the grant information.

13. The method of claim 12, wherein the at least one signature indicates that the licensing data is signed by an entity authorized to provide the licensing data.

14. The method of claim 8, wherein the one or more attributes comprise:
one or more versions of the software application;
one or more editions of the software application; or
one or more configurations of the software application.

15. A computer-readable storage medium having program instructions recorded thereon that, when executed by at least one processor, perform a method for enabling offline activation for a software application installed on a computing device, the method comprising:
transmitting a request for licensing data for the software application installed on the computing device to an activation server maintained by a manufacturer of the computing device;
receiving the licensing data from the activation server; and
storing the licensing data in firmware of the computing device, the licensing data including binding data that binds the licensing data to the computing device and grant information that specifies one or more attributes of the software application that are authorized for use on the computing device, the licensing data enabling offline activation of the software application.

16. The computer-readable storage medium of claim 15, the method further comprising:
generating an identifier that identifies the computing device, the identifier being based on at least one hardware parameter of at least one hardware component included in the computing device, wherein the request includes the identifier.

17. The computer-readable storage medium of claim 16, wherein the binding data comprises the identifier.

18. The computer-readable storage medium of claim 16, wherein the at least one hardware parameter comprises one or more of:
a serial number of the at least one hardware component;
a media access control number of the at least one hardware component; or
a device identifier of the at least one hardware component.

19. The computer-readable storage medium of claim 16, the method further comprising:
detecting the licensing data stored in the firmware;
determining that the identifier included in the binding data of the licensing data matches the identifier generated by the computing device;
determining that the computing device comprises at least one signature verifying the authenticity of the licensing data;
determining that the software application installed on the computing device comprises the one or more attributes specified by the grant information; and
activating the software application in response to determining that the identifier included in the binding data of the licensing data matches the identifier generated by the computing device, determining that the licensing data comprises the signature, and determining that the software application installed on the computing device comprises the one or more attributes specified by the grant information.

20. The computer-readable storage medium of claim 19, wherein the at least one signature indicates that the licensing data is signed by an entity authorized to provide the licensing data.
